(19) United States
(12) Patent Application Publication
(10) Pub. No.: US 2006/0070926 A1
(43) Pub. Date: Apr. 6, 2006

(54) Screen design for screen cylinder of headbox

(75) Inventor: Chia-Yin Wei, Miaoli Shien (TW)

Correspondence Address: BRUCE H. TROXELL, SUITE 1404, 5205 LEESBURG PIKE, FALLS CHURCH, VA, 22041, US

(73) Assignee: A One Machinery Co., Ltd.

(21) Appl. No.: 10/915,403

(22) Filed: Aug. 11, 2004

(51) Int. Cl. B07B 1/49

(52) U.S. Cl. 209/393; 209/400

(57) ABSTRACT

The screen cylinder of the invention comprises a supporting bar and a plurality of screen wires. The supporting bar has a predefined thickness and has a plurality of troughs arranged thereon with equal spacing, wherein each trough has a convex therein. The screen wire has an inset end and an extending end. A side of the inset end is arranged with a near-rectangle recess such that the recess can accept the convex of the trough while insetting the screen wire into a corresponding trough of the supporting bar. The extending end is protruding outwardly from the surface of the supporting bar. The screen cylinder as disclosed in the present invention has better structural integrity and smaller tolerance variation, and as the consequence that the resulting paper quality is enhanced.

### FIELD OF THE INVENTION

The present invention relates to a screen for screen cylinder, and more particularly, to screen cylinder configured by insetting a plurality of screen wires on a supporting bar.

### BACKGROUND OF THE INVENTION

Headbox screens represent the last line of defense against contaminants before pulp is made into paper. In a headbox screen, the total structural integrity of the screen cylinder thereof is directly related to the aperture tolerance of the same, and both can have major affect on the resulting paper quality. In this regard, manufacturers have been making every efforts to improve the screen design and structural integrity of screen cylinder so as to achieve the requirements such as stable slot width (i.e. smaller tolerance), assemble convenience and low maintenance.

Please refer to FIG. 1, which is a 3-D diagram showing a screen for screen cylinder according to prior arts. The screen cylinder 9 comprises a supporting bar 91 and a plurality of screen wires, wherein each screen wire is welded to a corresponding recess 93 of the supporting bar 91. The screen cylinder 9 formed by welding has poor structural integrity that the screen wire will be loosen and even fall off by negative pressure caused by the centrifugal force during a screening operation.

To improve the foregoing disadvantage, another screen cylinder 8 is provided as seen in FIG. 2. The screen cylinder 8 comprises a supporting bar 81 and a plurality of screen wires, wherein each screen wire is inset into a trough 83 which is further fixed by welding. However, the improved structure of screen cylinder 8 is still vulnerable to the negative pressure that can be drawn out of the trough and fall off.

To further enhance the joint strength between the supporting bar and the screen wire, an inset type screen cylinder is developed recently as seen in FIG. 3. the screen cylinder 7 comprises a supporting bar 71 and a plurality of screen wires 72, wherein the screen wire has a ball-shaped inset end 74 matched with the ball-topped trough 74 such that the joint strength between the supporting bar and the screen wire is enhanced. However, the screen cylinder 7 still has the shortcomings of large tolerance and weak structural integrity since the screen wire might not inset into the supporting bar deep enough and the ball-shaped inset end is still vulnerable to the negative pressure.

### SUMMARY OF THE INVENTION

The primary object of the invention is to provide a screen cylinder with better structural integrity and smaller tolerance. Since the screen cylinder of the present invention has screen wires inset into a supporting bar with sufficient insetting depth which each further has an inset end with a near-rectangle recess matched with a convex formed inside the trough of the supporting bar, the screen wires are fixed solid, the screen cylinder is durable with long life span and is easy to assemble without welding, and as the consequences that the manufacturing cost is reduced.

To achieve the abovementioned object, the screen cylinder of the invention comprises a supporting bar and a plurality of screen wires. The supporting bar has a predefined thickness and has a plurality of troughs arranged thereon with equal spacing, wherein each trough has a convex therein. The screen wire has an inset end and an extending end. A side of the inset end is arranged with a near-rectangle recess such that the recess can accept the convex of the trough while insetting the screen wire into a corresponding trough of the supporting bar. The extending end is protruding outwardly from the surface of the supporting bar and has a predefined width, where the predefined width is smaller than the spacing between troughs of the supporting bar. In addition, the screen wire is inset into the supporting bar by a predefined depth which is larger than a half of the predefined thickness.

Following drawings are cooperated to describe the detailed structure and its connective relationship according to the invention for facilitating your esteemed members of reviewing committee in understanding the characteristics and the objectives of the invention.

### BRIEF DESCRIPTION OF THE DRAWINGS

FIG. 1 is a 3-D diagram showing a screen of a screen cylinder according to prior arts.

FIG. 2 is a 3-D diagram showing another screen of a screen cylinder according to prior arts.

FIG. 3 is a 3-D diagram showing yet another screen of a screen cylinder according to prior arts.

FIG. 4 is a sectional view of a screen of a screen cylinder according to the present invention.

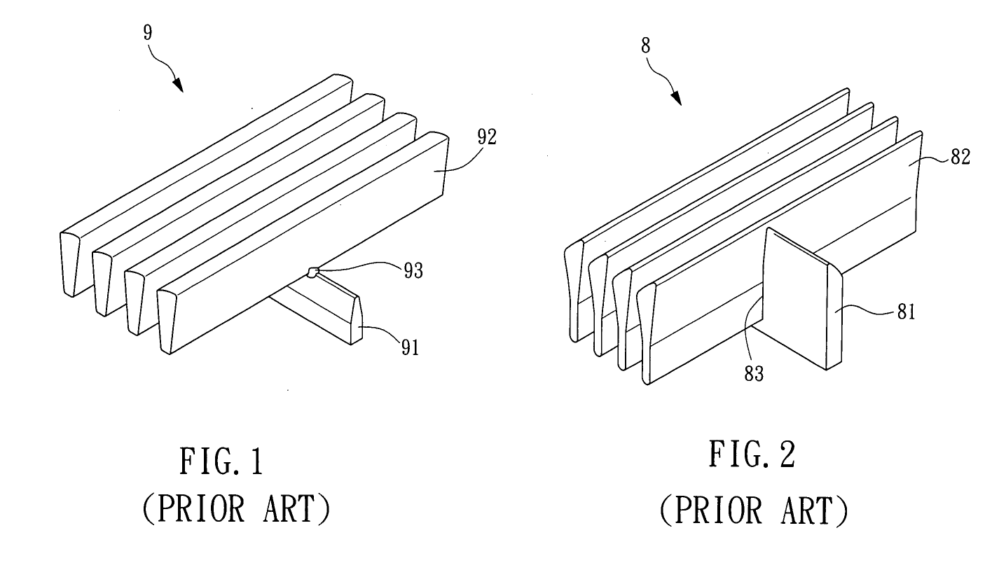

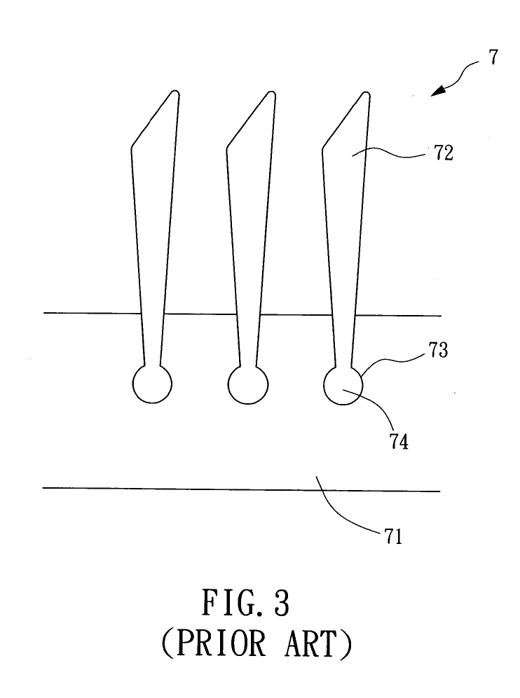

### DESCRIPTION OF THE PREFERRED EMBODIMENT

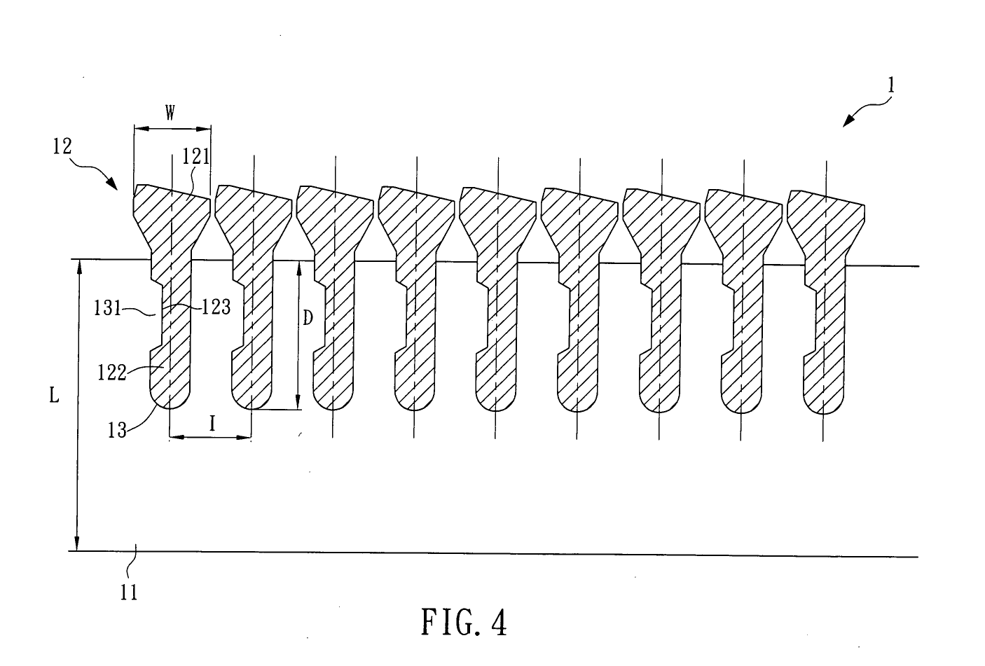

Please refer to FIG. 4, which is a sectional view of a screen of a screen cylinder according to the present invention. The screen cylinder 1 of FIG. 4 comprises a supporting bar 111 and a plurality of screen wires 12. The supporting bar 11 has a predefined thickness L and has a plurality of troughs 13 arranged thereon with equal spacing I, wherein each trough 13 has a convex 131 therein. Although the convex 131 is formed in near rectangular shape, it can be formed in any geometry shape. The screen wire has an inset end 122 and an extending end 121. A side of the inset end 122 is arranged with a near-rectangle recess 123 such that the recess 123 can accept the convex 131 of the trough 13 while insetting the screen wire 12 into a corresponding trough 13 of the supporting bar 11. The extending end 121 is protruding outwardly from the surface of the supporting bar 11 and has a predefined width W, where the predefined width W is smaller than the spacing I between troughs of the supporting bar. In addition, the screen wire is inset into the supporting bar by a predefined depth D which is larger than a half of the predefined thickness, i.e. ½ L. Moreover, in a preferred embodiment of the present invention, the supporting bar 11 is a circular bar.

In this regard, while this embodiment is operating in high-speed rotation, since the overall structural integrity is enhanced such that the screen wire is stably fixed, the tolerance (I-W) of the screen cylinder is not going to vary accordingly that a constant flow can be maintained.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A screen for a screen cylinder, comprising:
a supporting bar with a predefined thickness, having a plurality of troughs arranged thereon with equal spacing, and each trough 13 having a convex 131 formed therein.
a plurality of screen wires, having an inset end and an extending end, wherein a side of the inset end is arranged with a near-rectangle recess for accepting the convex of a corresponding trough, and the extending end is protruding outwardly from the surface of the supporting bar.

2. The screen for a screen cylinder of claim 1, wherein the extending end has a predefined width and the predefined width is smaller than the spacing between two troughs.

3. The screen for a screen cylinder of claim 1, wherein the screen wire is inset into the supporting bar by a predefined depth and the predefined depth is larger than a half of the predefined thickness.

4. The screen for a screen cylinder of claim 1, wherein the screen wire is inset into the supporting bar by a predefined depth and the predefined depth is equal to a half of the predefined thickness.

5. The screen for a screen cylinder of claim 1, wherein the supporting bar is a circular bar.
